(19) United States
(12) Patent Application Publication
(10) Pub. No.: US 2026/0059529 A1
(43) Pub. Date: Feb. 26, 2026

(54) SYSTEMS AND METHODS FOR MULTI-PANEL SIMULTANEOUS PHYSICAL UPLINK CONTROL CHANNEL TRANSMISSIONS

(71) Applicant: APPLE INC., Cupertino, CA (US)

(72) Inventors: Haitong Sun, Cupertino, CA (US); Chunxuan Ye, San Diego, CA (US); Seyed Ali Akbar Fakoorian, San Diego, CA (US); Dawei Zhang, Saratoga, CA (US); Wei Zeng, San Diego, CA (US); Chunhai Yao, Beijing (CN)

(21) Appl. No.: 19/099,512

(22) PCT Filed: Aug. 10, 2022
(86) PCT No.: PCT/CN2022/111518

§ 371 Date: Jan. 29, 2025

(51) Int. Cl. H04W 72/21; H04B 7/0404; H04L 1/08; H04W 52/14

(52) U.S. Cl. CPC H04W 72/21; H04B 7/0404; H04L 1/08; H04W 52/146

(57) ABSTRACT

Systems and methods for multi-panel simultaneous physical uplink control channel (PUCCH) transmissions are discussed herein. A user equipment (UE) may be configured by a network to perform first PUCCH transmission(s) on a first antenna panel and second PUCCH transmission(s) on a second antenna panel. These multi-panel simultaneous PUCCH transmissions are configured such that they are operable within the overall wireless communication system even as they overlap in a time domain. Options for configuring multi-panel simultaneous PUCCHs are discussed. Embodiments where multi-panel simultaneous PUCCH transmissions use a same PUCCH resource configuration are discussed. Embodiments where multi-panel simultaneous PUCCH transmissions use different PUCCH resource configurations are discussed. Embodiments for the use of multi-panel simultaneous PUCCH transmissions under PUCCH repetition schemes configured by the network are discussed.

### TECHNICAL FIELD

This application relates generally to wireless communication systems, including wireless communications systems using multi-panel simultaneous PUCCH transmissions.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram showing multi-panel simultaneous PUCCH transmissions by a UE.

FIG. 2 illustrates a diagram showing manners of sending multi-panel simultaneous PUCCH transmissions according to embodiments herein.

FIG. 3 illustrates a diagram a first option for multi-panel simultaneous PUCCH transmissions using PUCCH repetition, according to embodiments herein.

FIG. 4 illustrates a diagram a second option for multi-panel simultaneous PUCCH transmissions using PUCCH repetition, according to embodiments herein.

FIG. 5 illustrates a diagram of a third option for multi-panel simultaneous PUCCH transmissions using PUCCH repetition, according to embodiments herein.

FIG. 6 illustrates a diagram of various options for PUCCH formats.

FIG. 7 illustrates a method of a UE, according to embodiments herein.

FIG. 8 illustrates a method of a UE, according to embodiments herein.

FIG. 9 illustrates a method of a RAN, according to embodiments herein.

FIG. 10 illustrates a method of a RAN, according to embodiments herein.

FIG. 11 illustrates a method of a UE, according to embodiments herein,

FIG. 12 illustrates a method of a RAN, according to embodiments herein.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communications systems, a physical uplink control channel (PUCCH) transmission may be configured through the use of PUCCH configuration information (e.g., as found in a PUCCH-Config information element) that indicates a PUCCH resource configuration for the PUCCH transmission. Further, in some networks, a medium access control control element (MAC CE) may then be used to specify and/or change one or more properties of the PUCCH transmission. In each of FR1 and FR2, one or more power control parameter(s) of the PUCCH transmission, including a PO parameter, a pathloss reference signal parameter, and a closed loop power control (CLPC) index may be set by MAC CE. In FR2, it may further be that a transmit (Tx) spatial filter used for the PUCCH transmission is set by MAC CE.

Systems and methods disclosed herein anticipate the use of multi-panel simultaneous PUCCH transmissions by a UE. To perform multi-panel simultaneous PUCCH transmissions, a UE may utilize multiple antenna panels, with one antenna panel used for one or more (differing) PUCCH transmissions. Further, the multi-panel simultaneous PUCCH transmissions are configured such that they are operable with the wireless communication system even as they overlap in time (whether fully or partially).

The multi-panel simultaneous PUCCH transmissions described herein may occur in, for example, a same component carrier (CC) and/or a same frequency band as each other. For example, it may be understood that a first PUCCH transmission sent on a first antenna panel as described herein is on a same CC and/or same frequency band as a simultaneous PUCCH transmission sent on a second antenna panel.

The multi-panel simultaneous PUCCH transmissions described herein may occur in, for example, frequencies that are close to each other. For example, it may be understood that a first PUCCH transmission sent on a first antenna panel as described herein is on a first frequency that is close to a second frequency for a simultaneous PUCCH transmission sent on a second antenna panel.

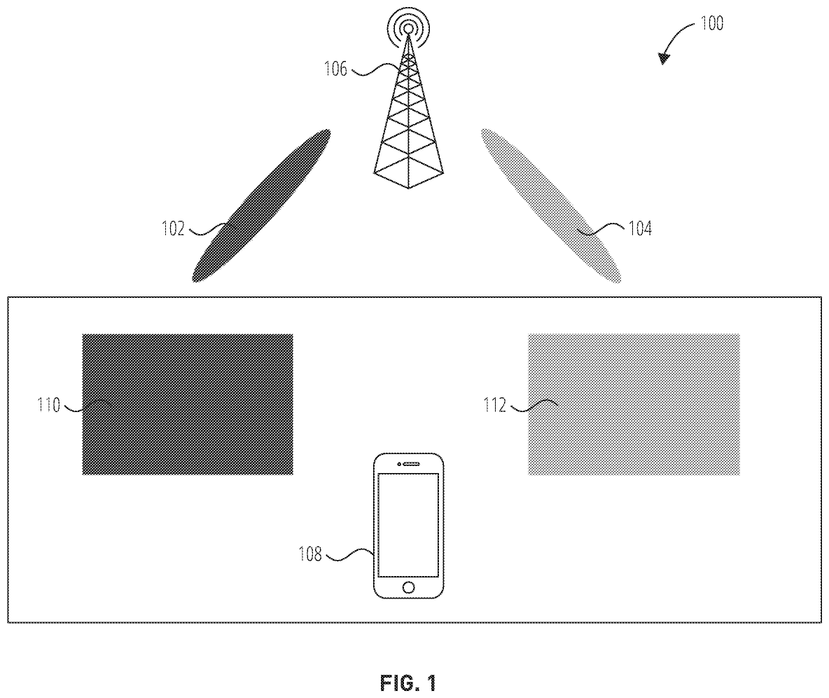

FIG. 1 illustrates a diagram 100 showing multi-panel simultaneous PUCCH transmissions 102, 104 by a UE 108. The multi-panel simultaneous PUCCH transmissions use the first antenna panel 110 and the second antenna panel 112. As illustrated, the first PUCCH transmission 102 is sent to the network (e.g., the base station 106) by the UE 108 using the first antenna panel 110, while the second PUCCH transmission 104 is simultaneously sent to the network (e.g., the base station 106) by the UE 108 using the second antenna panel 112. The first PUCCH transmission 102 and the second PUCCH transmission 104 may overlap in time either fully or only partially.

It is noted that while the first antenna panel 110 and the second antenna panel 112 have been illustrated external to the UE 108 for reasons of explanation here, it will be understood that these may be components of the UE 108 itself. It is further noted that the use of a single base station 106 of the network is given by way of example and not by way of limitation. It may be, in other embodiments, that, for example, a first PUCCH transmission is directed to/received at a first reception point (RP) (e.g., base station) of the network while a second PUCCH transmission is directed to/received at another RP of the network.

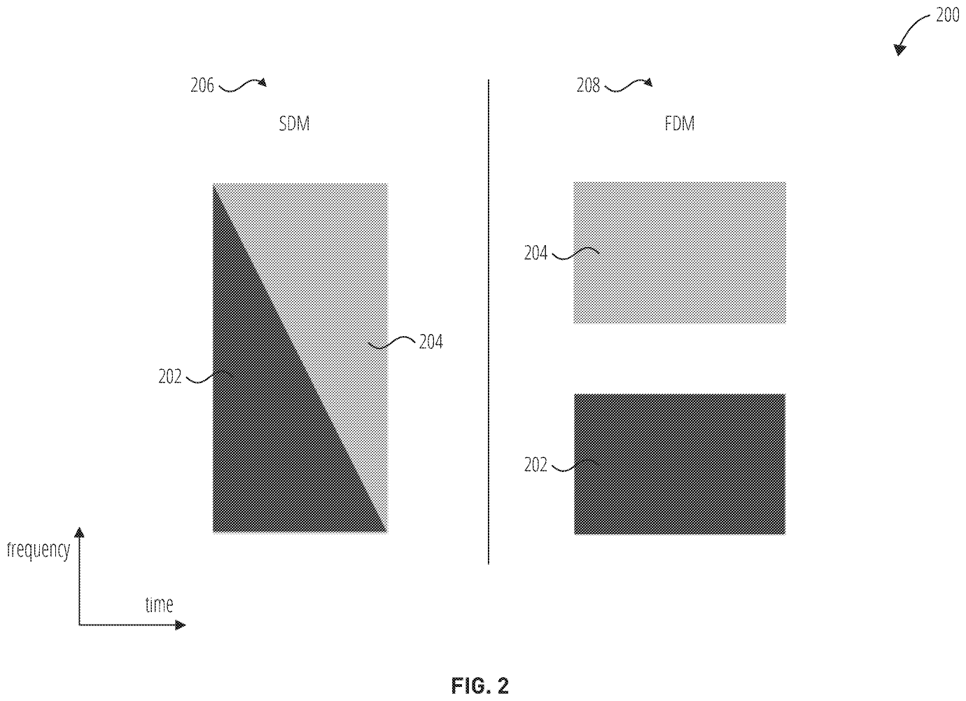

FIG. 2 illustrates a diagram 200 showing manners of sending multi-panel simultaneous PUCCH transmissions 202, 204, according to embodiments herein. As illustrated, in some cases, a first PUCCH transmission 202 and a second PUCCH transmission 204 may be sent in a spatial domain multiplexing (SDM) manner 206, in which case the first PUCCH transmission 202 that is sent on a first antenna panel and the second PUCCH transmission 204 that is sent on a second antenna panel are transmitted on overlapping time and frequency resources, but in different spatial resources.

In some cases, the first PUCCH transmission 202 and the second PUCCH transmission 204 may be sent in a frequency domain multiplexing (FDM) manner 208, in which case the first PUCCH transmission 202 that is sent on the first antenna panel and the second PUCCH transmission 204 that is sent on the second antenna panel are transmitted on overlapping time resources but in separate frequency resources.

Support for multi-panel simultaneous PUCCH transmissions may increase throughput and/or reliability within the wireless communication system. Use cases for multi-panel simultaneous PUCCH transmissions include, but are not limited to, use in customer premises equipment (CPEs), use in fixed wireless access (FWA) equipment, use in vehicles, use in industrial devices, etc.

Discussion herein relates various details regarding the use of multi-panel simultaneous PUCCH transmissions. For example, certain options to the use of multi-panel simultaneous PUCCH transmissions may be applied within a wireless communication system to promote organization and/or rationality for the use of the same within the wireless communication system. Details regarding the use of multi-panel simultaneous PUCCH transmissions that are based on a same PUCCH resource configuration are discussed. Further, details regarding the use of multi-panel simultaneous PUCCH transmissions that are based on different PUCCH resource configurations are discussed.

### Options for Multi-Panel Simultaneous PUCCH Transmissions

In some cases, a network configures a UE to perform multi-panel simultaneous PUCCH transmissions in a certain manner. Some such certain manners relate to the frequency domain. For example, in some cases, the simultaneous PUCCH transmissions are configured to be non-overlapping in the frequency domain. In other cases, the simultaneous PUCCH transmissions are configured to be completely overlapping in the frequency domain. In other cases, the simultaneous PUCCH transmissions are configured to be either completely overlapping in the frequency domain or non-overlapping in the frequency domain (such that the simultaneous PUCCH transmissions do not only partially overlap in the frequency domain).

Some certain manners of multi-panel simultaneous PUCCH transmissions relate to the time domain. For example, in some cases, the simultaneous PUCCH transmissions are configured to completely overlap in the time domain.

In some cases, a network configures a UE to perform multi-panel simultaneous PUCCH transmissions with each such PUCCH transmission being transmitted with a different Tx spatial filter. A pair of Tx spatial filters used (e.g., a pair of quasi-colocation (QCL) reference signals used) can be configured to the UE by the network. In some cases, the configuration of the pair of Tx spatial filters may be based on a group-based downlink (DL) measurement report received at the network from the UE. In some cases, the configuration of the pair of Tx spatial filters may be based on a Tx spatial filter pair in a layer 1 (L1) measurement report received at the network from the UE.

In some cases where a network configures a UE to perform multi-panel simultaneous PUCCH transmissions, it may be that the PUCCHs are partially overlapping in the time domain (e.g., may start and/or end at different times). In such cases, if each PUCCH transmission carries the same uplink control information (UCI), various manners of determining relevant processing timeline requirements are considered. For example, for timeline definitions that consider a first symbol of a PUCCH transmission, an earliest symbol from among all the PUCCH transmissions may be used to determine the relevant processing timeline. Example processing timelines where the use of such an earliest symbol may include, for example, a hybrid automatic repeat request acknowledgement (HARQ-ACK) related timeline, a channel state information (CSI) report related timeline, and a UCI multiplexing related timeline.

For timeline definitions that consider a last symbol of a PUCCH transmission, a latest symbol from among all the PUCCH transmissions may be used to determine the relevant processing timeline. Example processing timelines where the use of such a latest symbol may include, for example, a MAC CE activation timeline, a MAC CE deactivation timeline, and a downlink hybrid automatic repeat request (HARQ) retransmission timeline restriction.

In some cases where a network configures a UE to perform multi-panel simultaneous PUCCH transmissions, each of the PUCCH transmissions is configured with the same priority. For example, it may be that the PUCCH resource configuration(s) for each of the PUCCH transmissions are present in a resourceToAddModList or in a resource ToAddModeListExt-v1610 in a PUCCH-config information element for the PUCCH transmissions.

In some cases where a network configures a UE to perform multi-panel simultaneous PUCCH transmissions, each of the PUCCH transmissions may use a same timing advance (TA).

### Multi-panel Simultaneous Pucch Transmissions Using a Same Pucch Resource Configuration

In some embodiments, multi-panel simultaneous PUCCH transmissions may each use a same PUCCH resource configuration. In some such cases, it may be that a MAC CE may be used to activate the PUCCH resource configuration with two (e.g., different) sets of parameters for two such PUCCH transmissions, with the result that the first PUCCH transmission is performed on a first antenna panel based on the PUCCH resource configuration and the first parameters from the MAC CE and the second PUCCH transmission is performed on a second antenna panel based on the PUCCH resource configuration and the second parameters from the MAC CE. In FR1, such parameters may include power control parameters (such as a P0 parameter, a pathloss reference signal parameter, and/or a closed loop power control (CLPC) index). In FR2, such parameters may include power control parameters (such as a P0 parameter, a pathloss reference signal parameter, and/or a CLPC index), and may additionally/alternatively include Tx spatial filters (e.g., applicable QCL reference signals)

In some embodiments of multi-panel simultaneous PUCCH transmissions that each use same PUCCH resource configuration, one or more information elements identifying one or more aspects related to simultaneous PUCCH transmission may be included in the PUCCH resource configuration. In some cases of simultaneous PUCCH transmissions that do not fully overlap in the frequency domain, the PUCCH resource configuration includes an information element identifying a frequency offset for the UE to apply between the simultaneous PUCCH transmissions. The frequency offset may be given in units of physical resource blocks (PRBs) in some embodiments.

In some cases of simultaneous PUCCH transmissions that do not fully overlap in the frequency domain, the PUCCH resource configuration includes an information element identifying a frequency interlace offset for the UE to apply between the simultaneous PUCCH transmissions (e.g., in cases of unlicensed band use).

In some cases of simultaneous PUCCH transmissions that do not fully overlap in the time domain, the PUCCH resource configuration includes an information element identifying a time offset for the UE to apply between the simultaneous PUCCH transmissions (e.g., corresponding to a partial overlap situation between the PUCCH transmissions). The time offset may be given in units of symbols in some embodiments.

In embodiments, multi-panel simultaneous PUCCH transmissions using a same PUCCH resource configuration may be non-overlapping in a frequency domain, may fully overlap in a frequency domain, may have a same priority, and/or use a same TA, as these have been described herein.

In some embodiments of multi-panel simultaneous PUCCH transmissions that each use a same PUCCH resource configuration, it may be that the PUCCH resource configuration is activated with two sets of Tx spatial filter and/or power control parameters (e.g., via MAC CE). In such cases, it may be that the network also configures the use of PUCCH repetition. As part of PUCCH repetition, it may be understood that a PUCCH transmission is transmitted/repeated (e.g., retransmitted using the same PUCCH/data payload) during transmission occasions for that PUCCH transmissions that are within a set of configured PUCCH repetition occasions.

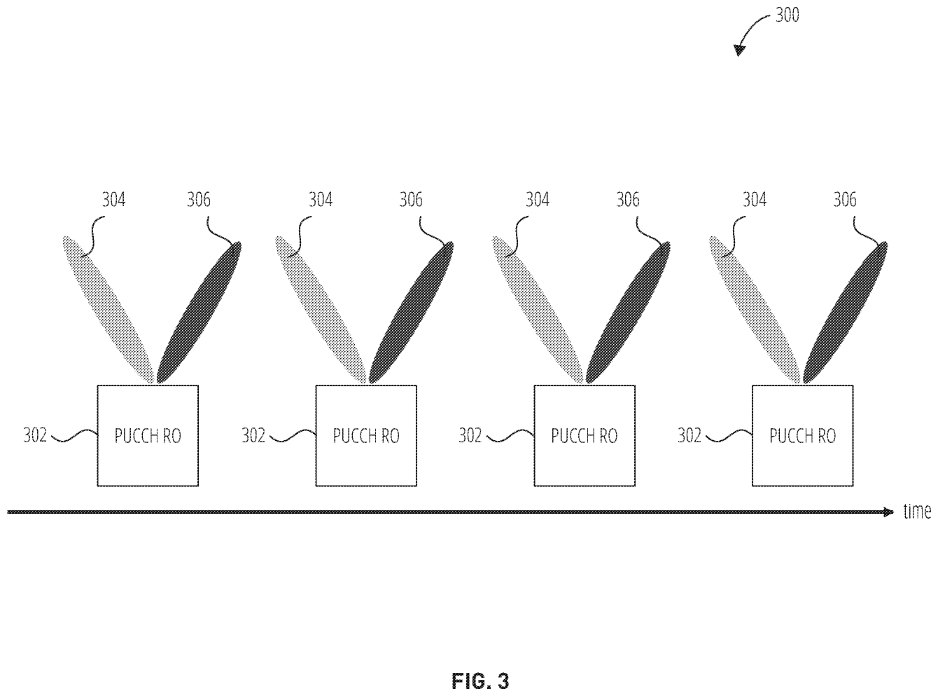

FIG. 3 illustrates a diagram 300 a first option (“option 1”) for multi-panel simultaneous PUCCH transmissions using PUCCH repetition, according to embodiments herein. The diagram 300 corresponds to the use of a single PUCCH configuration during PUCCH repetition occasions 302 according to the use of PUCCH repetition. Under option 1, UE performs first PUCCH transmissions 304 of a first PUCCH during a set of transmission occasions for the first PUCCH transmissions 304 that maps to each of the PUCCH repetition occasions 302. The first PUCCH transmissions 304 use a first Tx spatial filter and/or first power control parameters as provided by the network. Further, the UE (simultaneously) performs second PUCCH transmissions 306 of a second PUCCH during a set of transmission occasions for the second PUCCH transmissions 306 that (also) maps to each of the PUCCH repetition occasions 302. The second PUCCH transmissions 306 use a second Tx spatial filter and/or second power control parameters as provided by the network.

As illustrated, under option 1, the transmission occasions for the first PUCCH transmissions 304 occur during same PUCCH repetition occasions as the transmission occasions for the second PUCCH transmissions 306.

In some cases, the first PUCCH transmissions 304 and the second PUCCH transmissions 306 are non-overlapping in a frequency domain. In some cases, the first PUCCH transmissions 304 and the second PUCCH transmissions 306 fully overlap in a frequency domain. In some cases, the first PUCCH transmissions 304 and the second PUCCH transmissions 306 have a same priority. In some cases, the first PUCCH transmissions 304 and the second PUCCH transmissions 306 use a same TA.

In some cases, the Tx spatial filters may be based on a group-based DL measurement report received at the network from the UE. In some cases, the Tx spatial filters selected may be based on a transmission by the UE of an L1 measurement report containing one or more pairs of Tx spatial filters that the UE can simultaneously use with the first antenna panel and the second antenna panel.

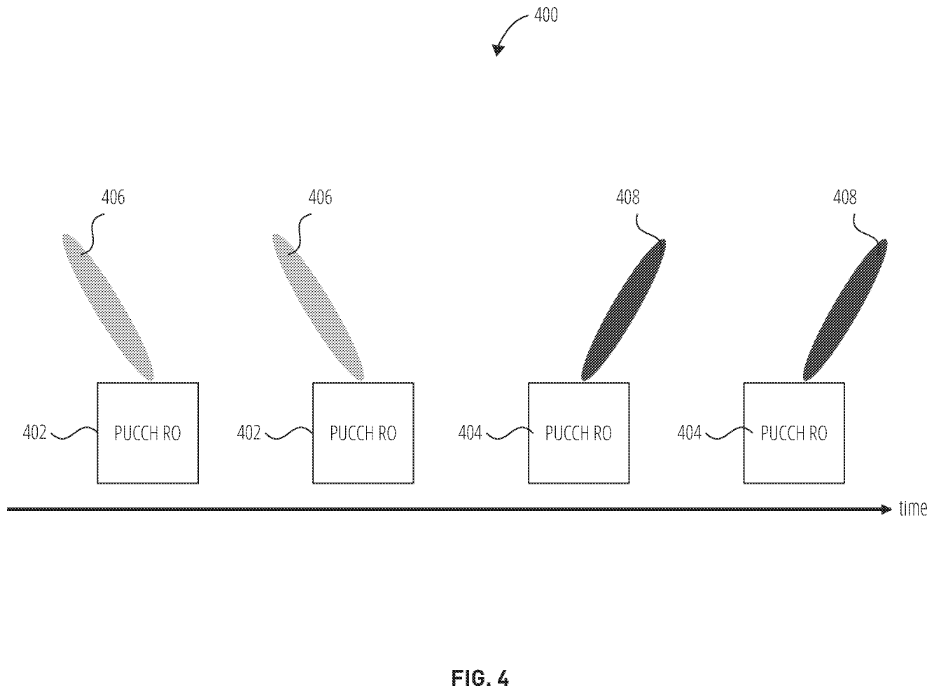

FIG. 4 illustrates a diagram 400 a second option (“option 2”) for multi-panel simultaneous PUCCH transmissions using PUCCH repetition, according to embodiments herein. The diagram 400 corresponds to the use of a single PUCCH configuration during first PUCCH repetition occasions 402 and second PUCCH repetition occasions 404 according to the use of PUCCH repetition. Under option 2, the UE performs first PUCCH transmissions 406 of a first PUCCH during a set of transmission occasions for the first PUCCH transmissions 406 that maps to each of the first PUCCH repetition occasions 402. The first PUCCH transmissions 406 use a first Tx spatial filter and/or first power control parameters as provided by the network. Further, the UE performs second PUCCH transmissions 408 of a second PUCCH during a set of transmission occasions for the second PUCCH transmissions 408 that maps to each of the second PUCCH repetition occasions 404. The second PUCCH transmissions 408 use a second Tx spatial filter and/or second power control parameters as provided by the network.

As illustrated, under option 2, the transmission occasions for the first PUCCH transmissions 406 occur during different PUCCH repetition occasions as the transmission occasions for the second PUCCH transmissions 408.

It should be understood that while the first PUCCH transmissions 406 and the second PUCCH transmissions 408 do not actually occur during same PUCCH repetition occasions, they may still be configured analogously as the PUCCH transmissions discussed herein that, e.g., overlap in the time domain. In this sense, the first PUCCH transmissions 406 and the second PUCCH transmissions 408 of the PUCCH repetition scheme illustrated in the diagram 400 may still be considered “multi-panel simultaneous PUCCH transmissions” as these are discussed herein.

In some cases, the first PUCCH transmissions 406 and the second PUCCH transmissions 408 are non-overlapping in a frequency domain. In some cases, the first PUCCH transmissions 406 and the second PUCCH transmissions 408 fully overlap in a frequency domain. In some cases, the first PUCCH transmissions 406 and the second PUCCH transmissions 408 have a same priority. In some cases, the first PUCCH transmissions 406 and the second PUCCH transmissions 408 use a same TA.

In some cases, the Tx spatial filters may be based on a group-based DL measurement report received at the network from the UE. In some cases, the Tx spatial filters selected may be based on a transmission by the UE of an L1 measurement report containing one or more pairs of Tx spatial filters that the UE can simultaneously use with the first antenna panel and the second antenna panel.

In some cases of multi-panel simultaneous PUCCH transmissions using PUCCH repetition, a network may configure up to four sets of parameters (e.g., four sets of power control parameters and/or Tx spatial filter parameters). In this case, a first pair of the parameters sets may be applied for the simultaneous PUCCH transmissions at some PUCCH repetition occasions, while a second pair of the parameter sets may be applied for the simultaneous PUCCH transmissions at other PUCCH repetition occasions.

FIG. S illustrates a diagram 500 of a third option (“option 3”) for multi-panel simultaneous PUCCH transmissions using PUCCH repetition, according to embodiments herein. The diagram 500 illustrates the use of multi-panel simultaneous PUCCH transmissions using a single PUCCH configuration during first PUCCH repetition occasions 502 and second PUCCH repetition occasions 504 according to the use of PUCCH repetition. Under option 3, the UE performs a first subset 506a of first PUCCH transmissions 506 of a first PUCCH during a first subset of a set of transmission occasions for the first PUCCH transmissions 506 that maps to each of the first PUCCH repetition occasions 502. The first subset 506a of the first PUCCH transmissions 506 uses a first Tx spatial filter and/or first power control parameters as provided by the network (e.g., as found in the first pair of parameter sets received from the network).

Further, the UE (simultaneously) performs a first subset 508a of the second PUCCH transmissions 508 of a second PUCCH during a first subset of a set of transmission occasions for the second PUCCH transmissions 508 that (also) maps to each of the first PUCCH repetition occasions 502. The first subset 508a of the second PUCCH transmissions 508 uses a second Tx spatial filter and/or second power control parameters as provided by the network (e.g., as found in the first pair of parameter sets received from the network).

The UE further performs a second subset 506b of the first PUCCH transmissions 506 of the first PUCCH during a second subset of the set of transmission occasions for the first PUCCH transmissions 506 that maps to each of the second PUCCH repetition occasions 504. The second subset 506b of the first PUCCH transmissions 506 uses a third Tx spatial filter and/or third power control parameters as provided by the network (e.g., as found in the second pair of parameter sets received from the network).

Further, the UE (simultaneously) performs a second subset 508b of the second PUCCH transmissions 508 of the second PUCCH during a second subset of the set of transmission occasions for the second PUCCH transmissions 508 that (also) maps to each of the second PUCCH repetition occasions 504. The second subset 508b of the second PUCCH transmissions 508 uses a fourth Tx spatial filter and/or fourth power control parameters as provided by the network (e.g., as found in the second pair of parameter sets received from the network).

As illustrated, under option 3, the transmission occasions for the first PUCCH transmissions 506 occur during same PUCCH repetition occasions as the transmission occasions for the second PUCCH transmissions 508.

In some cases, the first PUCCH transmissions 506 and the second PUCCH transmissions 508 are non-overlapping in a frequency domain. In some cases, the first PUCCH transmissions 506 and the second PUCCH transmissions 508 fully overlap in a frequency domain. In some cases, the first PUCCH transmissions 506 and the second PUCCH transmissions 508 have a same priority. In some cases, the first PUCCH transmissions 506 and the second PUCCH transmissions 508 use a same timing advance (TA).

In some cases, the Tx spatial filters may be based on a group-based DL measurement report received at the network from the UE. In some cases, the Tx spatial filters selected may be based on a transmission by the UE of an L1 measurement report containing one or more pairs of Tx spatial filters that the UE can simultaneously use with the first antenna panel and the second antenna panel.

It is contemplated that, in alternative cases to options 1, 2 and 3 as discussed herein, if a network provides that multi-panel simultaneous PUCCH transmission using a same PUCCH configuration is to occur with PUCCH repetition (whether simultaneously or otherwise), the UE treats this as an error case that the UE is not expected to handle.

### Multi-panel Simultaneous PUCCH Transmissions Using Different PUCCH Resource Configurations

In some embodiments, multi-panel simultaneous PUCCH transmissions may use different PUCCH resource configurations, with a different PUCCH resource configuration used for different PUCCH transmissions on different antenna panels.

In embodiments, multi-panel simultaneous PUCCH transmissions using different PUCCH resource configurations may be non-overlapping in a frequency domain, may fully overlap in a frequency domain, may have a same priority, and/or use a same TA.

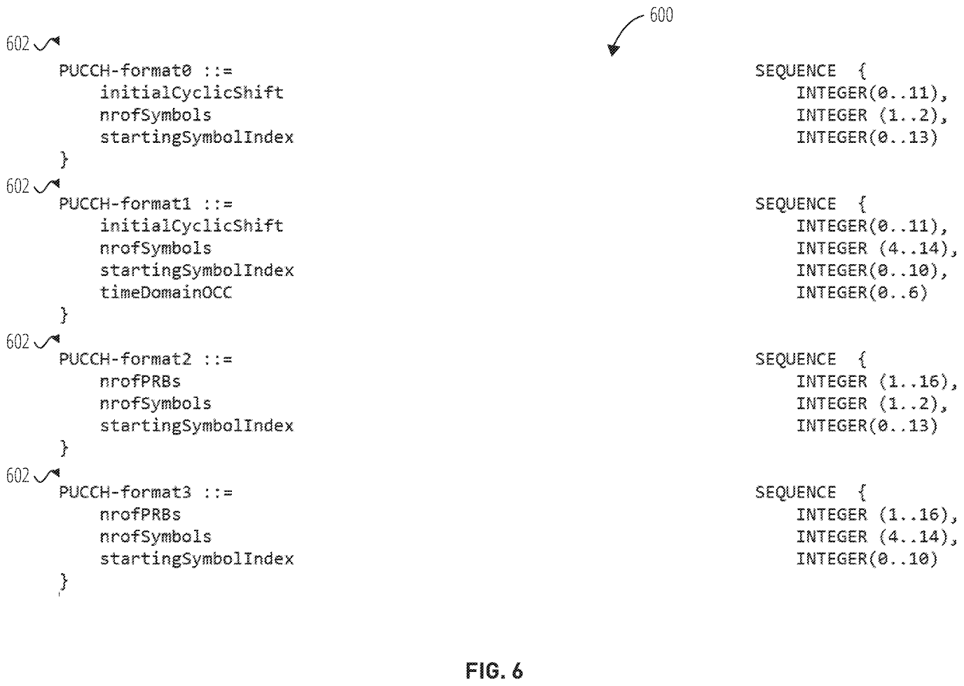

In some embodiments, when a network configures a UE to perform multi-panel simultaneous PUCCH transmission using different PUCCH resource configurations, it may be that certain parameters of the (multiple) PUCCH resource configurations are the same or similar. FIG. 6 illustrates a diagram 600 of various options for PUCCH formats 602. For example, the PUCCH resource configurations may use a same PUCCH format (e.g., according to one of the PUCCH formats 602 of the diagram 600). Further, the PUCCH resource configurations may use a same frequency hopping scheme (e.g., a same “intraSlotFrequencyHopping” parameter),

Other parameters of the (multiple) PUCCH resource configurations may be different. For example, a first PUCCH resource configuration may use a first initial cyclic shift (e.g., an “initialCyclicShift” parameter) while a second PUCCH resource configuration may use a second initial cyclic shift. As a further example, a first PUCCH resource configuration may use a first orthogonal cover code (OCC) (e.g., a “timeDomainOCC” parameter or as corresponding to an “occ-Index” parameter) while a second PUCCH resource configuration may use a second OCC.

In some embodiments, when a network configures a UE to perform multi-panel simultaneous PUCCH transmission using different PUCCH resource configurations, the network may configure/indicate two PUCCH resource configurations for such use simultaneously. For example, in some cases, a downlink control information (DCI) received from the network may include two PUCCH resource indicator fields, each field indicating one of the two PUCCH resource configurations. In some cases, a CSI report received from the network may include two PUCCH resource lists (e.g., two “pucch-CSI-ResourceList” objects in a CSI-ReportConfig information element (IE)), where the first PUCCH resource configuration is identified from the first PUCCH resource list and the second PUCCH resource configuration is identified from the second PUCCH resource list. In some cases, a scheduling request (SR) resource configuration (e.g., a “SchedulingRequestResourceConfig” object) is received from the network that indicates the first PUCCH resource configuration and the second PUCCH resource configuration. In some cases, a semi-persistent scheduling (SPS) configuration (e.g., an SPS-Config IE) is received from the network that indicates the first PUCCH resource configuration and the second PUCCH resource configuration (e.g., via the inclusion/use of multiple “n1PUCCH-AN,” “sps-PUCCH-AN-ResourceID-r16”, and/or “n1PUCCH-AN-PUCCHsSCell-r17” IEs).

In some embodiments, when a network configures a UE to perform multi-panel simultaneous PUCCH transmissions using different PUCCH resource configurations, the network may configure (e.g., at the UE) a link between two PUCCH resource configurations. Then, by indicating (e.g., only) a first PUCCH resource configuration, the UE can both identify the first PUCCH resource configuration (as indicated) for use with first PUCCH transmission(s) on a first antenna panel and can further identify the second (linked) PUCCH resource configuration (based on its link to the first PUCCH resource configuration) for use for second PUCCH transmission(s) on a second antenna panel.

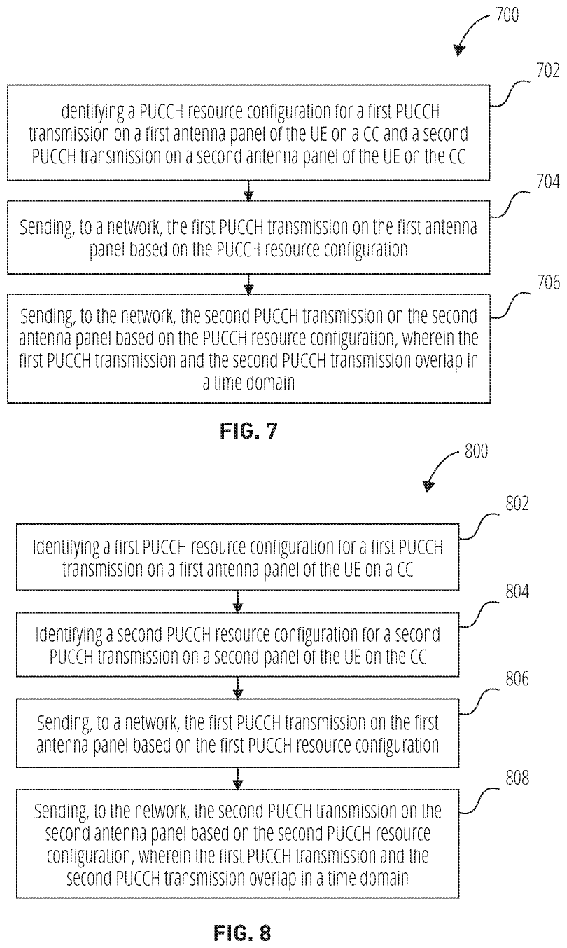

FIG. 7 illustrates a method 700 of a UE, according to embodiments herein. The method 700 includes identifying 702 a PUCCH resource configuration for a first PUCCH transmission on a first antenna panel of the UE on a CC and a second PUCCH transmission on a second antenna panel of the UE on the CC.

The method 700 further includes sending 704, to a network, the first PUCCH transmission on the first antenna panel based on the PUCCH resource configuration.

The method 700 further includes sending 706, to the network, the second PUCCH transmission on the second antenna panel based on the PUCCH resource configuration, wherein the first PUCCH transmission and the second PUCCH transmission overlap in a time domain.

In some embodiments, the method 700 further includes receiving, from the network, a MAC CE identifying first one or more power control parameters for the first PUCCH transmission and second one or more power control parameters for the second PUCCH transmission, wherein the first PUCCH transmission is performed on the first antenna panel based on the first power control parameters and the second PUCCH transmission is performed on the second antenna panel based on the second power control parameters.

In some embodiments, the method 700 further includes receiving, from the network, a MAC CE identifying a first Tx spatial filter for the first PUCCH transmission and a second Tx spatial filter for the second PUCCH transmission, wherein the first PUCCH transmission Is performed on the first antenna panel using the first Tx spatial filter and the second PUCCH transmission is performed on the second antenna panel based on the second Tx spatial filter.

In some embodiments of the method 700, the PUCCH resource configuration comprises an information element identifying a frequency offset between the first PUCCH transmission and the second PUCCH transmission, and the first PUCCH transmission and the second PUCCH transmission are offset by the frequency offset.

In some embodiments of the method 700, the PUCCH resource configuration comprises an information element identifying a frequency interlace offset between the first PUCCH transmission and the second PUCCH transmission, and the first PUCCH transmission and the second PUCCH transmission are offset by the frequency interlace offset.

In some embodiments of the method 700, the PUCCH resource configuration comprises an information element identifying a time offset between the first PUCCH transmission and the second PUCCH transmission, and the first PUCCH transmission and the second PUCCH transmission are offset by the time offset.

In some embodiments of the method 700, the first PUCCH transmission and the second PUCCH transmission are non-overlapping in a frequency domain.

In some embodiments of the method 700, the first PUCCH transmission and the second PUCCH transmission fully overlap in a frequency domain.

In some embodiments of the method 700, the first PUCCH transmission and the second PUCCH transmission fully overlap in the time domain.

In some embodiments, the method 700 further includes transmitting, to the network, an Ll measurement report containing one or more pairs of Tx spatial filters that the UE can simultaneously use with the first antenna panel and the second antenna panel.

In some embodiments of the method 700, the first PUCCH transmission and the second PUCCH transmission are not fully overlapping in the time domain and carry same UCI, and the method 700 further includes using an earliest symbol from the first PUCCH transmission and the second PUCCH transmission to determine one or more of a HARQ-ACK related timeline, a CSI report related timeline, and a UCI multiplexing related timeline.

In some embodiments of the method 700, the first PUCCH transmission and the second PUCCH transmission are not fully overlapping in the time domain and carry same UCI, and the method 700 further includes using a latest symbol from the first PUCCH transmission and the second PUCCH transmission to determine one or more of a MAC CE activation timeline, a MAC CE deactivation timeline, and a downlink HARQ retransmission timeline restriction.

In some embodiments of the method 700, the first PUCCH transmission and the second PUCCH transmission have a same priority.

In some embodiments of the method 700, the first PUCCH transmission and the second PUCCH transmission use a same timing advance TA.

In alternative embodiments that are analogous to the method 700 and its various possibilities as just discussed, the first PUCCH transmission and the second PUCCH transmission may be on the same frequency band but not necessarily on the same CC. In other alternative embodiments that are analogous to the method 700 and its various possibilities as just discussed, the first PUCCH transmission and the second PUCCH transmission may be on close frequencies rather than the same CC.

FIG. 8 illustrates a method 800 of a UE, according to embodiments herein. The method 800 includes identifying 802 a first PUCCH resource configuration for a first PUCCH transmission on a first antenna panel of the UE on a CC.

The method 800 further includes identifying 804 a second PUCCH resource configuration for a second PUCCH transmission on a second panel of the UE on the CC.

The method 800 further includes sending 806, to a network, the first PUCCH transmission on the first antenna panel based on the first PUCCH resource configuration.

The method 800 further includes sending 808, to the network, the second PUCCH transmission on the second antenna panel based on the second PUCCH resource configuration, wherein the first PUCCH transmission and the second PUCCH transmission overlap in a time domain.

In some embodiments of the method 800, the first PUCCH resource configuration is identified based on a first PUCCH resource indicator field in a DCI received from the network, and wherein the second PUCCH resource configuration is identified based on a second PUCCH resource indicator field in the DCL

In some embodiments of the method 800, the first PUCCH resource configuration is identified from a first PUCCH resource list in a CSI report configuration received from the network, and wherein the second PUCCH resource configuration is identified from a second PUCCH resource list in the CSI report configuration.

In some embodiments of the method 800, the first PUCCH resource configuration and the second PUCCH resource configuration are identified using a SR resource configuration received from the network that indicates the first PUCCH resource configuration and the second PUCCH resource configuration.

In some embodiments of the method 800, the first PUCCH resource configuration and the second PUCCH resource configuration are identified using an SPS configuration received from the network that indicates the first PUCCH resource configuration and the second PUCCH resource configuration.

In some embodiments, the method 800 further includes receiving, from the network, an indication of a link between the first PUCCH resource configuration and the second PUCCH resource configuration and receiving, from the network, an indication of the first PUCCH resource configuration, wherein the identifying of the first PUCCH resource configuration is performed using the indication of the first PUCCH resource configuration and the identifying of the second PUCCH resource configuration is performed based on the link between the first PUCCH resource configuration and the second PUCCH resource configuration.

In some embodiments of the method 800, the first PUCCH resource configuration and the second PUCCH resource configuration use a same PUCCH format. In some such embodiments, the first PUCCH resource configuration uses a first initial cyclic shift and the second PUCCH resource configuration uses a second initial cyclic shift. In some such embodiments, the first PUCCH resource configuration uses a first index to a first OCC and the second PUCCH resource configuration uses a second index to a second OCC.

In some embodiments of the method 800, the first PUCCH resource configuration and the second PUCCH resource configuration use a same frequency hopping scheme.

In some embodiments of the method 800, the first PUCCH transmission and the second PUCCH transmission are non-overlapping in a frequency domain.

In some embodiments of the method 800, the first PUCCH transmission and the second PUCCH transmission fully overlap in a frequency domain.

In some embodiments of the method 800, the first PUCCH transmission and the second PUCCH transmission fully overlap in the time domain.

In some embodiments, the method 800 further includes transmitting, to the network, a layer 1 (L1) measurement report containing one or more pairs of Tx spatial filters that the UE can simultaneously use with the first antenna panel and the second antenna panel.

In some embodiments of the method 800, the first PUCCH transmission and the second PUCCH transmission are not fully overlapping in the time domain and carry same UCI, and the method 700 further includes using an earliest symbol from the first PUCCH transmission and the second PUCCH transmission to determine one or more of a HARQ-ACK related timeline, a CSI report related timeline, and a UCI multiplexing related timeline.

In some embodiments of the method 800, the first PUCCH transmission and the second PUCCH transmission are not fully overlapping in the time domain and carry same UCI, and the method 700 further includes using a latest symbol from the first PUCCH transmission and the second PUCCH transmission to determine one or more of a MAC CE activation timeline, a MAC CE deactivation timeline, and a downlink HARQ retransmission timeline restriction.

In some embodiments of the method 800, the first PUCCH transmission and the second PUCCH transmission have a same priority.

In some embodiments of the method 800, the first PUCCH transmission and the second PUCCH transmission use a same timing advance TA.

In alternative embodiments that are analogous to the method 800 and its various possibilities as just discussed, the first PUCCH transmission and the second PUCCH transmission may be on the same frequency band but not necessarily on the same CC. In other alternative embodiments that are analogous to the method 800 and its various possibilities as just discussed, the first PUCCH transmission and the second PUCCH transmission may be on close frequencies rather than the same CC.

FIG. 9 illustrates a method 900 of a RAN, according to embodiments herein. The method 900 includes configuring 902 a UE to perform a first PUCCH transmission on a first antenna panel of the UE and a second PUCCH transmission on a second antenna panel at the UE, the first PUCCH transmission and the second PUCCH transmission overlapping in a time domain, wherein the configuring comprises identifying, to the UE, a single PUCCH resource configuration for each of the first PUCCH transmission and the second PUCCH transmission.

The method 900 further includes receiving 904, from the UE, the first PUCCH transmission and the second PUCCH transmission.

In some embodiments, the method 900 further includes sending, to the UE, a MAC CE identifying first one or more power control parameters for the first PUCCH transmission and second one or more power control parameters for the second PUCCH transmission.

In some embodiments, the method 900 further includes sending, to the UE, a MAC CE identifying a first Tx spatial filter for the first PUCCH transmission and a second Tx spatial filter for the second PUCCH transmission. In some such embodiments, the method 900 further includes determining the first Tx spatial filter and the second Tx spatial filter based on a group-based beam measurement report received from the UE. In some such embodiments, the method 900 further includes determining the first Tx spatial filter and the second Tx spatial filter based on a Tx spatial filter pair in a LI measurement report received from the UE.

In some embodiments of the method 900, the first PUCCH transmission and the second PUCCH transmission are non-overlapping in a frequency domain.

In some embodiments of the method 900, the first PUCCH transmission and the second PUCCH transmission fully overlap in a frequency domain.

In some embodiments of the method 900, the first PUCCH transmission and the second PUCCH transmission fully overlap in the time domain.

In some embodiments of the method 900, the first PUCCH transmission and the second PUCCH transmission have a same priority.

In some embodiments of the method 900, the first PUCCH transmission and the second PUCCH transmission use a same timing advance TA.

In alternative embodiments that are analogous to the method 900 and its various possibilities as just discussed, the first PUCCH transmission and the second PUCCH transmission may be on the same frequency band but not necessarily on the same CC. In other alternative embodiments that are analogous to the method 900 and its various possibilities as just discussed, the first PUCCH transmission and the second PUCCH transmission may be on close frequencies rather than the same CC.

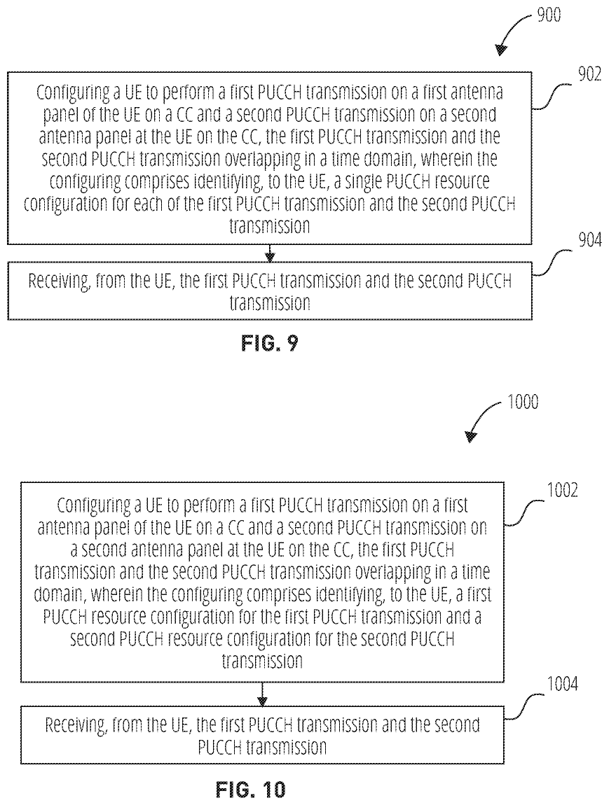

FIG. 10 illustrates a method 1000 of a RAN, according to embodiments herein. The method 1000 includes configuring 1002 a UE to perform a first PUCCH transmission on a first antenna panel of the UE and a second PUCCH transmission on a second antenna panel at the UE, the first PUCCH transmission and the second PUCCH transmission overlapping in a time domain, wherein the configuring comprises identifying, to the UE, a first PUCCH resource configuration for the first PUCCH transmission and a second PUCCH resource configuration for the second PUCCH transmission.

The method 1000 further includes receiving 1004, from the UE, the first PUCCH transmission and the second PUCCH transmission.

In some embodiments of the method 1000, the first PUCCH resource configuration is identified using a first PUCCH resource indicator field in a DCI sent to the UE, and wherein the second PUCCH resource configuration is indicated using a second PUCCH resource indicator field in the DCI.

In some embodiments of the method 1000, the first PUCCH resource configuration is identified using a first PUCCH resource list in a CSI report configuration sent to the UE, and wherein the second PUCCH resource configuration is indicated using a second PUCCH resource list in the CSI report configuration.

In some embodiments of the method 1000, the first PUCCH resource configuration and the second PUCCH resource configuration are identified using a SR resource configuration sent to the UE that indicates the first PUCCH resource configuration and the second PUCCH resource configuration.

In some embodiments of the method 1000, the first PUCCH resource configuration and the second PUCCH resource configuration are identified using a SPS configuration sent to the UE that indicates the first PUCCH resource configuration and the second PUCCH resource configuration.

In some embodiments of the method 1000, the identifying the first PUCCH resource configuration and the second PUCCH resource configuration comprises indicating, to the UE, a link between a first PUCCH resource configuration and a second PUCCH resource configuration; and indicating, to the UE, that the first PUCCH resource configuration is for the first PUCCH transmission.

In some embodiments of the method 1000, the first PUCCH transmission and the second PUCCH transmission are non-overlapping in a frequency domain.

In some embodiments of the method 1000, the first PUCCH transmission and the second PUCCH transmission fully overlap in a frequency domain.

In some embodiments of the method 1000, the first PUCCH transmission and the second PUCCH transmission fully overlap in the time domain.

In some embodiments of the method 1000, the first PUCCH transmission and the second PUCCH transmission have a same priority.

In some embodiments of the method 1000, the first PUCCH transmission and the second PUCCH transmission use a same timing advance TA.

In alternative embodiments that are analogous to the method 1000 and its various possibilities as just discussed, the first PUCCH transmission and the second PUCCH transmission may be on the same frequency band but not necessarily on the same CC. In other alternative embodiments that are analogous to the method 1000 and its various possibilities as just discussed, the first PUCCH transmission and the second PUCCH transmission may be on close frequencies rather than the same CC.

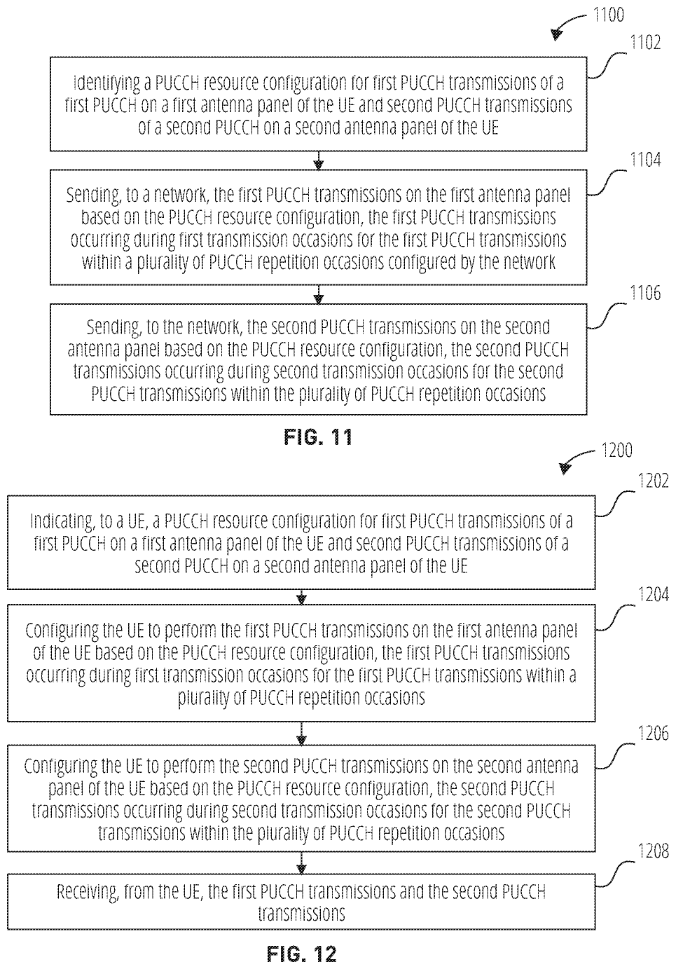

FIG. 11 illustrates a method 1100 of a UE, according to embodiments herein. The method 1100 includes identifying 1102 a PUCCH resource configuration for first PUCCH transmissions of a first PUCCH on a first antenna panel of the UE on a CC and second PUCCH transmissions of a second PUCCH on a second antenna panel of the UE on the CC.

The method 1100 further includes sending 1104, to a network, the first PUCCH transmissions on the first antenna panel based on the PUCCH resource configuration, the first PUCCH transmissions occurring during first transmission occasions for the first PUCCH transmissions within a plurality of PUCCH repetition occasions configured by the network.

The method 1100 further includes sending 1106, to the network, the second PUCCH transmissions on the second antenna panel based on the PUCCH resource configuration, the second PUCCH transmissions occurring during second transmission occasions for the second PUCCH transmissions within the plurality of PUCCH repetition occasions.

In some embodiments of the method 1100, the first PUCCH transmissions are performed on the first antenna panel using a first Tx spatial filter received from the network and based on first power control parameters received from the network, and the second PUCCH transmissions are performed on the second antenna panel using a second Tx spatial filter received from the network and based on second power control parameters received from the network.

In some embodiments of the method 1100, the first transmission occasions for the first PUCCH transmissions occur during same ones of the plurality of PUCCH repetition occasions as the second transmission occasions for the second PUCCH transmissions.

In some embodiments of the method 1100, the first transmission occasions for the first PUCCH transmissions occur during ones of the plurality of PUCCH repetition occasions where the second transmission occasions for the second PUCCH transmissions do not occur.

In some embodiments of the method 1100, a first subset of the first transmission occasions for the first PUCCH transmissions that correspond to a first subset of the first PUCCH transmissions occur during same ones of the plurality of PUCCH repetition occasions as a first subset of the second transmission occasions for the second PUCCH transmissions that correspond to a first subset of the second PUCCH transmissions, the first subset of the first PUCCH transmissions are performed on the first antenna panel using a first Tx spatial filter received from the network and based on first power control parameters received from the network, and the first subset of the second PUCCH transmissions are performed on the second antenna panel using a second Tx spatial filter received from the network and based on second power control parameters received from the network. In some such embodiments, a second subset of the first transmission occasions for the first PUCCH transmissions that correspond to a second subset of the first PUCCH transmissions occur during same ones of the plurality of PUCCH repetition occasions as a second subset of the second transmission occasions for the second PUCCH transmissions that correspond to a second subset of the second PUCCH transmissions, the second subset of the first PUCCH transmissions are performed on the first antenna panel using a third Tx spatial filter received from the network and based on third power control parameters received from the network, and the second subset of the second PUCCH transmissions are performed on the second antenna panel using a fourth Tx spatial filter received from the network and based on fourth power control parameters received from the network.

In some embodiments of the method 1100, the first PUCCH transmissions and the second PUCCH transmissions are non-overlapping in a frequency domain.

In some embodiments of the method 1100, the first PUCCH transmissions and the second PUCCH transmissions fully overlap in a frequency domain.

In some embodiments of the method 1100, the first PUCCH transmissions and the second PUCCH transmissions fully overlap in a time domain.

In some embodiments, the method 1100 further includes transmitting, to the network, a layer 1 (L1) measurement report containing one or more pairs of Tx spatial filters that the UE can simultaneously use with the first antenna panel and the second antenna panel.

In some embodiments of the method 1100, the first PUCCH transmissions and the second PUCCH transmissions have a same priority.

In some embodiments of the method 1100, the first PUCCH transmissions and the second PUCCH transmissions use a same timing advance (TA).

In alternative embodiments that are analogous to the method 1100 and its various possibilities as just discussed, the first PUCCH transmissions and the second PUCCH transmissions may be on the same frequency band but not necessarily on the same CC. In other alternative embodiments that are analogous to the method 1100 and its various possibilities as just discussed, the first PUCCH transmissions and the second PUCCH transmissions may be on close frequencies rather than the same CC.

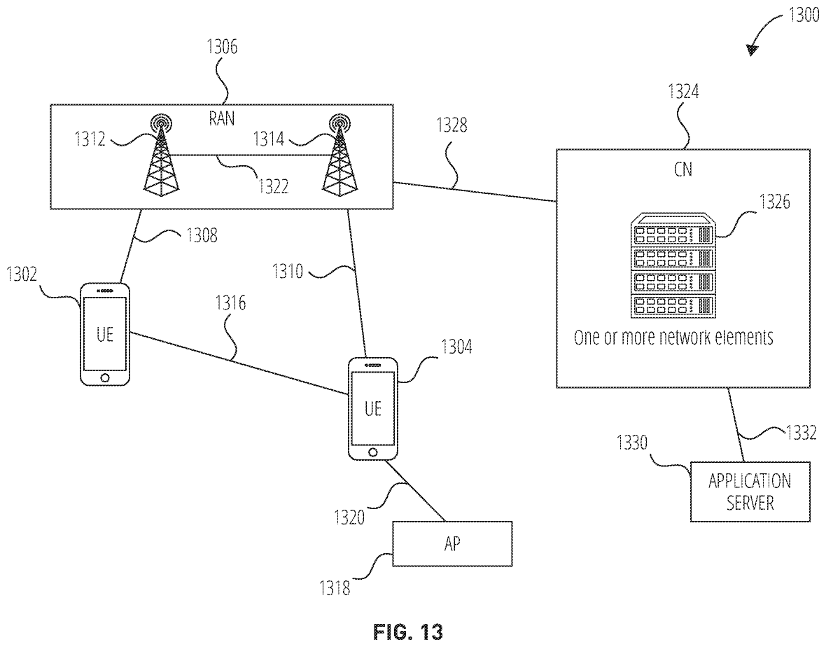

FIG. 12 illustrates a method 1200 of a RAN, according to embodiments herein. The method 1200 includes indicating 1202, to a UE, a PUCCH resource configuration for first PUCCH transmissions of a first PUCCH on a first antenna panel of the UE on a CC and second PUCCH transmissions of a second PUCCH on a second antenna panel of the UE on a CC.

The method 1200 further includes configuring 1204 the UE to perform the first PUCCH transmissions on the first antenna panel of the UE based on the PUCCH resource configuration, the first PUCCH transmissions occurring during first transmission occasions for the first PUCCH transmissions within a plurality of PUCCH repetition occasions.

The method 1200 further includes configuring 1206 the UE to perform the second PUCCH transmissions on the second antenna panel of the UE based on the PUCCH resource configuration, the second PUCCH transmissions occurring during second transmission occasions for the second PUCCH transmissions within the plurality of PUCCH repetition occasions.

The method 1200 further includes receiving 1208, from the UE, the first PUCCH transmissions and the second PUCCH transmissions.

In some embodiments, the method 1200 further includes transmitting, to the UE, a first Tx spatial filter and first power control parameters for the first PUCCH transmissions, and transmitting, to the UE, a second Tx spatial filter and second power control parameters for the second PUCCH transmissions.

In some embodiments of the method 1200, the first transmission occasions for the first PUCCH transmissions occur during same ones of the plurality of PUCCH repetition occasions as the second transmission occasions for the second PUCCH transmissions.

In some embodiments of the method 1200, the first transmission occasions for the first PUCCH transmissions occur during ones of the plurality of PUCCH repetition occasions where the second transmission occasions for the second PUCCH transmissions do not occur.

In some embodiments of the method 1200, a first subset of the first transmission occasions for the first PUCCH transmissions that correspond to a first subset of the first PUCCH transmissions occur during same ones of the plurality of PUCCH repetition occasions as a first subset of the second transmission occasions for the PUCCH transmissions that correspond to a first subset of the second PUCCH transmissions, and the method 1200 further includes transmitting, to the UE, a first Tx spatial filter and first power control parameters for the first subset of the first PUCCH transmissions and transmitting, to the UE, a second Tx spatial filter and second power control parameters for the first subset of the second PUCCH transmissions. In some such embodiments, a second subset of the first transmission occasions for the first PUCCH transmissions that correspond to a second subset of the first PUCCH transmissions occur during same ones of the plurality of PUCCH repetition occasions as a second subset of the second transmission occasions for the second PUCCH transmissions that correspond to a second subset of the second PUCCH transmissions, and the method 1200 further includes transmitting, to the UE, a third Tx spatial filter and third power control parameters for the second subset of the first PUCCH transmissions and transmitting, to the UE, a fourth Tx spatial filter and fourth power control parameters for the second subset of the second PUCCH transmissions.

In some embodiments of the method 1200, the first PUCCH transmissions and the second PUCCH transmissions are non-overlapping in a frequency domain.

In some embodiments of the method 1200, the first PUCCH transmissions and the second PUCCH transmissions fully overlap in a frequency domain.

In some embodiments of the method 1200, the first PUCCH transmissions and the second PUCCH transmissions fully overlap in a time domain.

In some embodiments of the method 1200, the first PUCCH transmissions and the second PUCCH transmissions have a same priority.

In some embodiments of the method 1200, the first PUCCH transmissions and the second PUCCH transmissions use a same timing advance (TA).

In alternative embodiments that are analogous to the method 1200 and its various possibilities as just discussed, the first PUCCH transmissions and the second PUCCH transmissions may be on the same frequency band but not necessarily on the same CC. In other alternative embodiments that are analogous to the method 1200 and its various possibilities as just discussed, the first PUCCH transmissions and the second PUCCH transmissions may be on close frequencies rather than the same CC.

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as base station 1312 and base station 1314) that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the KAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VolP sessions, group communication sessions, etc.) for the UE 1302 and UE 1304 via the CN 1324. The application server 1330 may communicate with the CN 1324 through an IP communications interface 1332.

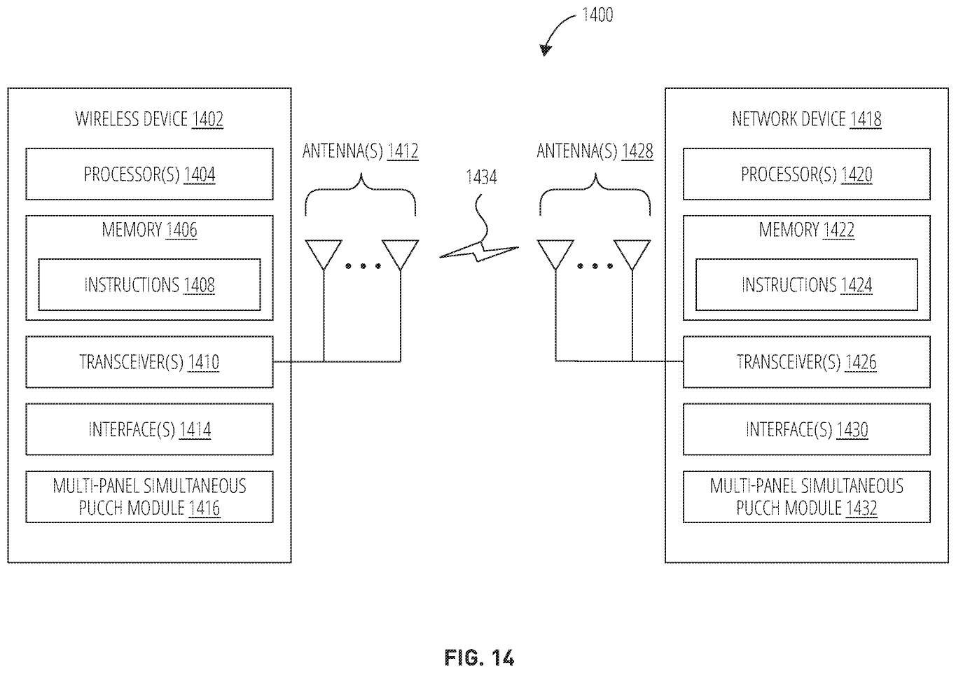

FIG. 14 illustrates a system 1400 for performing signaling 1434 between a wireless device 1402 and a network device 1418, according to embodiments disclosed herein. The system 1400 may be a portion of a wireless communications system as herein described. The wireless device 1402 may be, for example, a UE of a wireless communication system. The network device 1418 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1434) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a multi-panel simultaneous PUCCH module 1416. The multi-panel simultaneous PUCCH module 1416 may be implemented via hardware, software, or combinations thereof. For example, the multi-panel simultaneous PUCCH module 1416 may be implemented as a processor, circuit, and/or instructions 1408 stored in the memory 1406 and executed by the processor(s) 1404. In some examples, the multi-panel simultaneous PUCCH module 1416 may be integrated within the processor(s) 1404 and/or the transceiver(s) 1410. For example, the multi-panel simultaneous PUCCH module 1416 may be implemented by a combination of software components (e.g., executed by a DSP or a general processor) and hardware components (e.g., logic gates and circuitry) within the processor(s) 1404 or the transceiver(s) 1410.

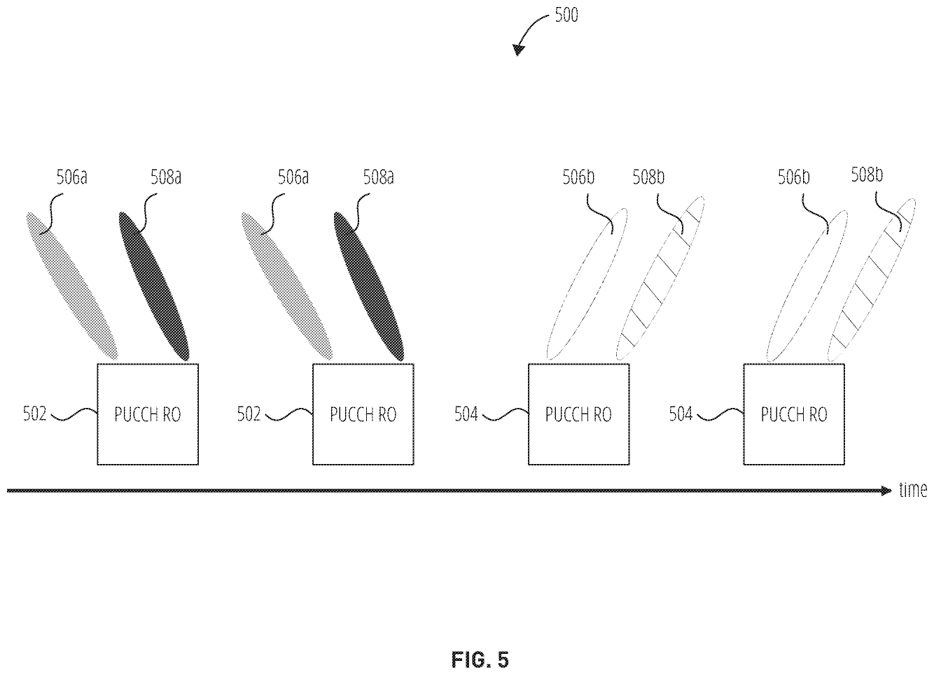

The multi-panel simultaneous PUCCH module 1416 may be used for various aspects of the present disclosure, for example, aspects of FIG. 1 through FIG. 12. The multi-panel simultaneous PUCCH module 1416 may configured to perform one or more operations of a UE for the use of multi-panel simultaneous PUCCHs, as these are described herein.

The network device 1418 may include one or more processor(s) 1420. The processor(s) 1420 may execute instructions such that various operations of the network device 1418 are performed, as described herein. The processor(s) 1420 may include one or more baseband processors implemented using, for example, a CPU, a DSP, an ASIC, a controller, an FPGA device, another hardware device, a firmware device, or any combination thereof configured to perform the operations described herein.

The network device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The network device 1418 may include one or more transceiver(s) 1426 that may include RF transmitter and/or receiver circuitry that use the antenna(s) 1428 of the network device 1418 to facilitate signaling (e.g., the signaling 1434) to and/or from the network device 1418 with other devices (e.g., the wireless device 1402) according to corresponding RATs.

The network device 1418 may include one or more antenna(s) 1428 (e.g., one, two, four, or more). In embodiments having multiple antenna(s) 1428, the network device 1418 may perform MIMO, digital beamforming, analog beamforming, beam steering, etc., as has been described.

The network device 1418 may include one or more interface(s) 1430. The interface(s) 1430 may be used to provide input to or output from the network device 1418. For example, a network device 1418 that is a base station may include interface(s) 1430 made up of transmitters, receivers, and other circuitry (e.g., other than the transceiver(s) 1426/antenna(s) 1428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1418 may include a multi-panel simultaneous PUCCH module 1432. The multi-panel simultaneous PUCCH module 1432 may be implemented via hardware, software, or combinations thereof. For example, the multi-panel simultaneous PUCCH module 1432 may be implemented as a processor, circuit, and/or instructions 1424 stored in the memory 1422 and executed by the processor(s) 1420. In some examples, the multi-panel simultaneous PUCCH module 1432 may be integrated within the processor(s) 1420 and/or the transceiver(s) 1426. For example, the multi-panel simultaneous PUCCH module 1432 may be implemented by a combination of software components (e.g., executed by a DSP or a general processor) and hardware components (e.g., logic gates and circuitry) within the processor(s) 1420 or the transceiver(s) 1426.

The multi-panel simultaneous PUCCH module 1432 may be used for various aspects of the present disclosure, for example, aspects of FIG. 1 through FIG. 12. The multi-panel simultaneous PUCCH module 1432 may configured to perform one or more operations of a network (e.g., a RAN) for the use of multi-panel simultaneous PUCCHs, as these are described herein. When performing the operations of the network, it may be that the network device 1418 works together with/in conjunction with other similar network devices.

Embodiments contemplated herein include an apparatus comprising means to perform one or more elements of any of the method 700, the method 800, and the method 1100. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 700, the method 800, and the method 1100. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of any of the method 700, the method 800, and the method 1100. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 700, the method 800, and the method 1100. This apparatus may be, for example, an apparatus of a UE (such as a wireless device 1402 that is a UE, as described herein).

Embodiments contemplated herein include a signal as described in or related to one or more elements of any of the method 700, the method 800, and the method 1100.

Embodiments contemplated herein include a computer program or computer program product comprising instructions, wherein execution of the program by a processor is to cause the processor to carry out one or more elements of any of the method 700, the method 800, and the method 1100. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

Embodiments contemplated herein include an apparatus comprising means to perform one or more elements of any of the method 900, the method 1000, and the method 1200. This apparatus may be, for example, an apparatus of a base station that is part of a RAN (such as a network device 1418 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 900, the method 1000, and the method 1200. This non-transitory computer-readable media may be, for example, a memory of a base station that is part of a RAN (such as a memory 1422 of a network device 1418 that is a base station, as described herein).

Embodiments contemplated herein include an apparatus comprising logic, modules, or circuitry to perform one or more elements of any of the method 900, the method 1000, and the method 1200. This apparatus may be, for example, an apparatus of a base station that is part of a RAN (such as a network device 1418 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 900, the method 1000, and the method 1200. This apparatus may be, for example, an apparatus of a base station that is part of a RAN (such as a network device 1418 that is a base station, as described herein).

Embodiments contemplated herein include a signal as described in or related to one or more elements of any of the method 900, the method 1000, and the method 1200.

Embodiments contemplated herein include a computer program or computer program product comprising instructions, wherein execution of the program by a processing element is to cause the processing element to carry out one or more elements of any of the method 900, the method 1000, and the method 1200. The processor may be a processor of a base station that is part of a RAN (such as a processor(s) 1420 of a network device 1418 that is a base station, as described herein). These instructions may be, for example, located in the processor and/or on a memory of the base station (such as a memory 1422 of a network device 1418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
identifying a physical uplink control channel (PUCCH) resource configuration for first PUCCH transmissions of a first PUCCH on a first antenna panel of the UE on a component carrier (CC) and second PUCCH transmissions of a second PUCCH on a second antenna panel of the UE on the CC;
sending, to a network, the first PUCCH transmissions on the first antenna panel based on the PUCCH resource configuration, the first PUCCH transmissions occurring during first transmission occasions for the first PUCCH transmissions within a plurality of PUCCH repetition occasions configured by the network;
sending, to the network, the second PUCCH transmissions on the second antenna panel based on the PUCCH resource configuration, the second PUCCH transmissions occurring during second transmission occasions for the second PUCCH transmissions within the plurality of PUCCH repetition occasions.

2. The method of claim 1, wherein:
the first PUCCH transmissions are performed on the first antenna panel using a first Tx spatial filter received from the network and based on first power control parameters received from the network; and
the second PUCCH transmissions are performed on the second antenna panel using a second Tx spatial filter received from the network and based on second power control parameters received from the network.

3. The method of claim 1, wherein the first transmission occasions for the first PUCCH transmissions occur during same ones of the plurality of PUCCH repetition occasions as the second transmission occasions for the second PUCCH transmissions.

4. The method of claim 1, wherein the first transmission occasions for the first PUCCH transmissions occur during ones of the plurality of PUCCH repetition occasions where the second transmission occasions for the second PUCCH transmissions do not occur.

5. The method of claim 1, wherein:
a first subset of the first transmission occasions for the first PUCCH transmissions that correspond to a first subset of the first PUCCH transmissions occur during same ones of the plurality of PUCCH repetition occasions as a first subset of the second transmission occasions for the second PUCCH transmissions that correspond to a first subset of the second PUCCH transmissions;
the first subset of the first PUCCH transmissions are performed on the first antenna panel using a first Tx spatial filter received from the network and based on first power control parameters received from the network; and
the first subset of the second PUCCH transmissions are performed on the second antenna panel using a second Tx spatial filter received from the network and based on second power control parameters received from the network.

6. The method of claim 5, wherein:
a second subset of the first transmission occasions for the first PUCCH transmissions that correspond to a second subset of the first PUCCH transmissions occur during same ones of the plurality of PUCCH repetition occasions as a second subset of the second transmission occasions for the second PUCCH transmissions that correspond to a second subset of the second PUCCH transmissions;
the second subset of the first PUCCH transmissions are performed on the first antenna panel using a third Tx spatial filter received from the network and based on third power control parameters received from the network; and
the second subset of the second PUCCH transmissions are performed on the second antenna panel using a fourth Tx spatial filter received from the network and based on fourth power control parameters received from the network.

7. The method of claim 1, wherein the first PUCCH transmissions and the second PUCCH transmissions are non-overlapping in a frequency domain.

8. The method of claim 1, wherein the first PUCCH transmissions and the second PUCCH transmissions fully overlap in a frequency domain.

9. The method of claim 1, wherein the first PUCCH transmissions and the second PUCCH transmissions fully overlap in a time domain.

10. The method of claim 1, further comprising transmitting, to the network, a layer 1 (L1) measurement report containing one or more pairs of transmit (Tx) spatial filters that the UE can simultaneously use with the first antenna panel and the second antenna panel.

11. The method of claim 1, wherein the first PUCCH transmissions and the second PUCCH transmissions have a same priority.

12. The method of claim 1, wherein the first PUCCH transmissions and the second PUCCH transmissions use a same timing advance (TA).

13. A method of a radio access network (RAN), comprising:
indicating, to a user equipment (UE), a physical uplink control channel (PUCCH) resource configuration for first PUCCH transmissions of a first PUCCH on a first antenna panel of the UE on a component carrier (CC) and second PUCCH transmissions of a second PUCCH on a second antenna panel of the UE on the CC;
configuring the UE to perform the first PUCCH transmissions on the first antenna panel of the UE based on the PUCCH resource configuration, the first PUCCH transmissions occurring during first transmission occasions for the first PUCCH transmissions within a plurality of PUCCH repetition occasions;
configuring the UE to perform the second PUCCH transmissions on the second antenna panel of the UE based on the PUCCH resource configuration, the second PUCCH transmissions occurring during second transmission occasions for the second PUCCH transmissions within the plurality of PUCCH repetition occasions; and
receiving, from the UE, the first PUCCH transmissions and the second PUCCH transmissions.

14. The method of claim 13, further comprising:
transmitting, to the UE, a first transmit (Tx) spatial filter and first power control parameters for the first PUCCH transmissions; and
transmitting, to the UE, a second Tx spatial filter and second power control parameters for the second PUCCH transmissions.

15. The method of claim 13, wherein the first transmission occasions for the first PUCCH transmissions occur during same ones of the plurality of PUCCH repetition occasions as the second transmission occasions for the second PUCCH transmissions.

16. The method of claim 13, wherein the first transmission occasions for the first PUCCH transmissions occur during ones of the plurality of PUCCH repetition occasions where the second transmission occasions for the second PUCCH transmissions do not occur.

17. The method of claim 13, wherein a first subset of the first transmission occasions for the first PUCCH transmissions that correspond to a first subset of the first PUCCH transmissions occur during same ones of the plurality of PUCCH repetition occasions as a first subset of the second transmission occasions for the PUCCH transmissions that correspond to a first subset of the second PUCCH transmissions; and further comprising:
transmitting, to the UE, a first transmit (Tx) spatial filter and first power control parameters for the first subset of the first PUCCH transmissions; and
transmitting, to the UE, a second Tx spatial filter and second power control parameters for the first subset of the second PUCCH transmissions.

18. The method of claim 17, wherein a second subset of the first transmission occasions for the first PUCCH transmissions that correspond to a second subset of the first PUCCH transmissions occur during same ones of the plurality of PUCCH repetition occasions as a second subset of the second transmission occasions for the second PUCCH transmissions that correspond to a second subset of the second PUCCH transmissions; and further comprising:
transmitting, to the UE, a third Tx spatial filter and third power control parameters for the second subset of the first PUCCH transmissions; and
transmitting, to the UE, a fourth Tx spatial filter and fourth power control parameters for the second subset of the second PUCCH transmissions.

19-21. (canceled)
